(19) United States
(12) Patent Application Publication
(10) Pub. No.: US 2024/0161134 A1
(43) Pub. Date: May 16, 2024

(54) SYSTEMS AND METHODS FOR IMPROVING FORECASTING MODELS

(71) Applicant: Genpact Luxembourg S.à r.l. II, Luxembourg (LU)

(72) Inventors: Tanya Kaintura, Noida (IN); Sayantan Banerjee, Kolkata (IN); Rajeev Ranjan, Bangalore (IN)

(21) Appl. No.: 17/988,373

(22) Filed: Nov. 16, 2022

(51) Int. Cl. G06Q 30/02; G06Q 10/06

(52) U.S. Cl. CPC G06Q 30/0202; G06Q 10/067

(57) ABSTRACT

The disclosure relates to a method for creating an improved forecasting model. The method includes identifying a plurality of drivers affecting actual sales or demand of a product or service; receiving a respective data set for each of the drivers; generating one or more lagged data sets for each driver by applying lags to the data set associated with the driver; for each driver: forming a group of data sets by grouping the data set associated with the driver with the lagged data sets for the driver; and selecting a data set in the group of data sets that best correlates with sales or demand changes of the product or service; determining which one or more of the selected data sets for the drivers increases forecasting accuracy for sales or demand of the product or service; and training a forecasting model using the one or more selected data sets.

### TECHNICAL FIELD

The present disclosure is directed to systems and methods for improving forecasting models for business decisions.

### BACKGROUND

Forecasting plays an important role in companies making informed business decisions and developing data-driven strategies. Based on current and historical data, forecasting models allow companies to create acceptable and achievable goals. Forecasting models also provide visibility into possible trends and changes, which assist companies in determining where to spend their budget and to focus on certain offerings such as products, services, or internal areas including hiring and strategy adjustments. However, business sales and demands data in the real-world have a lot of variability, and the data can be significantly affected by social media and occurrence of rare events such as a pandemic, which make the forecasting models less accurate. Therefore, there is a need to improve the forecasting models.

### SUMMARY

In one aspect, the subject matter of this disclosure relates to a method for creating an improved forecasting model, the method including identifying a plurality of drivers affecting actual sales or demand of a product or service; receiving a respective data set for each of the drivers; generating one or more lagged data sets for each driver by applying one or more lags to the data set associated with the driver; for each driver forming a group of data sets by grouping the data set associated with the driver with the one or more lagged data sets for the driver; and selecting a data set in the group of data sets that best correlates with sales or demand changes of the product or service; determining which one or more of the selected data sets for the drivers increases forecasting accuracy for sales or demand of the product or service; and training a forecasting model using the one or more selected data sets. The method may further include modifying the data set associated with at least one of the drivers to compensate for one or more rare events. The plurality of drivers may include one or more social media drivers and one or more non-social media drivers. The method may further include calculating error metric values for the forecasting model. The error metric values may include mean absolute percentage error and weighted average percentage error. The method may further include identifying the respective data set for each of the drivers based on a keywords dictionary before applying one or more lags to the data set, the keywords dictionary including misspelled words and shortened words for each of the drivers. The forecasting model may be used to predict demand based on new input data. The method may further includes cleansing the respective data set for each of the drivers before applying one or more lags to the data set.

In one aspect, the subject matter of this disclosure relates to a system for creating an improved forecasting model, the system may include a memory; and one or more processors coupled with the memory, wherein the one or more processors, when executed, perform operations including identifying a plurality of drivers affecting actual sales or demand of a product or service; receiving a respective data set for each of the drivers; generating one or more lagged data sets for each driver by applying one or more lags to the data set associated with the driver; for each driver forming a group of data sets by grouping the data set associated with the driver with the one or more lagged data sets for the driver; and selecting a data set in the group of data sets that best correlates with sales or demand changes of the product or service; determining which one or more of the selected data sets for the drivers increases forecasting accuracy for sales or demand of the product or service; and training a forecasting model using the one or more selected data sets. The operations may further include modifying the data set associated with at least one of the drivers to compensate for one or more rare events. The plurality of drivers may include one or more social media drivers and one or more non-social media drivers. The operations may further include calculating error metric values for the forecasting model. The error metric values may include mean absolute percentage error and weighted average percentage error. The operations may further include identifying the respective data set for each of the drivers based on a keywords dictionary before applying one or more lags to the data set, the keywords dictionary including misspelled words and shortened words for each of the drivers. The forecasting model may be used to predict demand based on new input data. The operations may further include cleansing the respective data set for each of the drivers before applying one or more lags to the data set.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates a flow diagram of three phases in a forecasting model, according to various embodiments of the present disclosure.

FIG. 2 illustrates a table including three different types of factors influencing sales or demand for identification in the phase I of a forecasting process, according to various embodiments of the present disclosure.

FIG. 3 illustrates a table including an exemplary possible incorrect tokens for a keyword during data identification in a forecasting process, according to various embodiments of the present disclosure.

FIG. 4 illustrates a table including an exemplary list of possible English alphabets for a key during data identification in a forecasting process, according to various embodiments of the present disclosure.

FIG. 5 illustrates a flow diagram of filtering misspelled tokens by an algorithm, according to various embodiments of the present disclosure.

FIG. 6 illustrates posts fetched using different keywords, according to various embodiments of the present disclosure.

FIG. 7 illustrates feature selection in a forecasting process, according to various embodiments of the present disclosure.

FIG. 8 illustrates a comparison of actual value and forecasted values generated from four forecasting models, according to various embodiments of the present disclosure.

FIG. 9 illustrates variability in actual data explained by different forecasting models, according to various embodiments of the present disclosure.

FIG. 10 illustrates an overview of improvement on forecast accuracy by including different macroeconomic drivers in a forecasting model, according to various embodiments of the present disclosure.

FIG. 11 illustrates an overview of improvement on forecast accuracy by including different supply chain drivers in a forecasting model, according to various embodiments of the present disclosure.

FIG. 12 illustrates a flow diagram of a forecasting modelling process, according to various embodiments of the present disclosure.

FIG. 13 illustrates an example of a type of user's computer, according to various embodiments of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Any dimension or example part called out in the figures are examples only, and the example embodiments described herein are not so limited.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Modern businesses have a variety of methods for forecasting and utilizing statistical data. The methods range from spreadsheets to complicated financial planning software. The methods include several options ranging from basic statistical forecasting to models that include deep learning approaches. However, workforce capacity fluctuations, inconsistencies in the supply chain, and production interruptions continue to be significant problems for the methods for forecasting. In addition, companies or organizations nowadays want an explanation of performance of the methods for forecasting, and to know why any abnormalities occur. Given the variabilities of data in the methods for forecasting, incorporating all factors affecting demand or sales to explain that trends and historical patterns are more important than before.

In one embodiment, based on current and historical data, a forecasting model may allow companies to create acceptable and achievable goals. The forecasting model may provide visibility into possible trends and the forecasting model may assist the companies in determining where to spend their budget and attention on certain offerings such as products, services, or internal areas including hiring and strategy adjustments. The forecasting model may help in anticipating market changes. For example, based on various data sources, the forecasting model may predict that demand for a particular product will increase or decrease over a future period of time.

In one embodiment, one or more items of key information about the market or business of a company may be obtained in order to assist the company in developing better strategies based on the forecast outcome from the forecasting model. The forecasting model may provide the company information, so the company may avoid potential failures or losses. Hence, the forecasting model becomes critical to forecast more accurately. In reality, real-world data has a lot of variability and the variability may make the forecasting model less accurate. In order to understand the variability, one or more factors directly or indirectly affecting demand of a business or a product may be incorporated into forecasting techniques in the forecasting model. For example, the one or more factors may be determined based on social media data or rare events such as a global pandemic.

In one embodiment, the one or more factors for the forecasting model mentioned above include social media data-based factors. Incorporating social media data along with macroeconomic variables and supply chain drivers into the forecasting model may improve accuracy. The coefficients of the forecasting model help inform whether the sentiment of the posts on the social media are negative or positive for a product, which helps companies or organizations make business decisions. The impact of social media on personal and professional lives has been far greater than expected. Social media provides a network for people to connect to each other. Social media can influence product sales when users post negative or positive reviews about the product. In some examples, the social media data may include the number of mentions of a product on a given social media platform, by keywords. Companies and other organizations spend a lot of money on appropriate social media campaigns and looking for the perfect influencer; therefore, social media marketing has become increasingly popular. Companies and other organizations are currently leveraging social media data to boost their exposure and traffic. The forecasting model based on the impact of social media also allows businesses or organizations to observe their customers in their natural environment. The social media factor in the forecasting model further provides market intelligence.

A majority of companies and organizations still predict their projections based on past sales or demand or a few supply chain factors. In the present disclosure, the method includes macroeconomic and social media data along with supply-chain drivers, which improves the accuracy of the prediction projections.

In one embodiment, the one or more factors for the forecasting model mentioned above include a rare events factor. Handling the rare event impacted data correctly is important in order to help the forecasting model interpretability and to predict accurately. For example, the rare events may include, but are not limited to, a global pandemic. Many time-series models in production did not see the rapid surge or drop in demand during the COVID-19 pandemic. Rare event impacted data increases the volatility in the forecasting data of the forecasting model which makes it very difficult to forecast accurately. In addition, in the occurrence of rare events such as the COVID-19 pandemic, a majority of people in the world and a lot of companies and other organizations are affected. When historical data is analyzed, it is obvious that there was significant impact caused by the COVID-19 pandemic. The COVID-19 pandemic has wreaked havoc on the global economy and social conditions. The COVID-19 pandemic has caused a significant disturbance in the demand for a variety of goods and services. For some sectors, such as digital food ordering, the COVID-19 pandemic was a short-term disruption and then the demand returned to previous levels over 6-12 months. For some products, such as hand sanitizers and masks, the impact from the COVID-19 pandemic resulted in more of a structural change with a long-term impact in the form of a sustained surge or drop in demand. For example, due to customer hoarding of some specific products, some product and service categories saw a demand increase of over 10 times, which caused supply chain instability. In some other examples, businesses such as airlines, reported a reduction of demand of over 60% as a result of the COVID pandemic. Therefore, rare events have a significant impact on the forecasting model.

In one embodiment, the forecasting model in the present disclosure includes combining social media data with macroeconomic factors and supply chain drivers to improve accuracy when forecasting demand or sales for products using techniques that capture both linear and non-linear trends or patterns in the data. The linear trend in the data may include a best fit straight line that is used with one or more simple data sets. The non-linear trend in the data may include data that cannot be fitted by a straight line and may use a function with quadratic or higher order trends for the forecasting model.

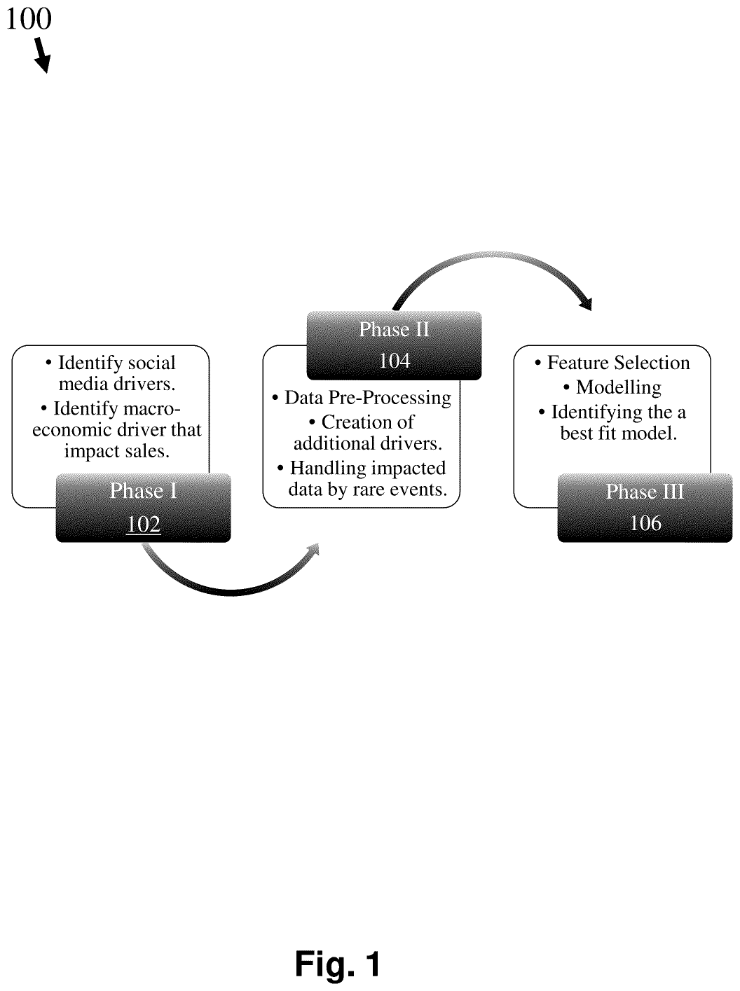

Referring to FIG. 1, a flow diagram 100 of three phases in a forecasting model is shown, according to various embodiments of the present disclosure.

In one embodiment, the forecasting model in the present disclosure includes three phases. Phase I 102 includes, but is not limited to, identifying social media drivers, identifying macro-economic driver that impact sales, identifying one or more elements that influence sales as well as obtaining social media data and macroeconomic indicators relevant to a target market. Phase II 104 includes, but is not limited to, pre-processing data, data treatment, creation of additional drivers, altering data from weekly to monthly or any level based on the use case, and generating additional features along with handling data impacted by the rare events. Phase III 106 includes, but is not limited to, selecting features, modeling, identifying a best fit model, and generating forecasts.

### Phase I Data Identification

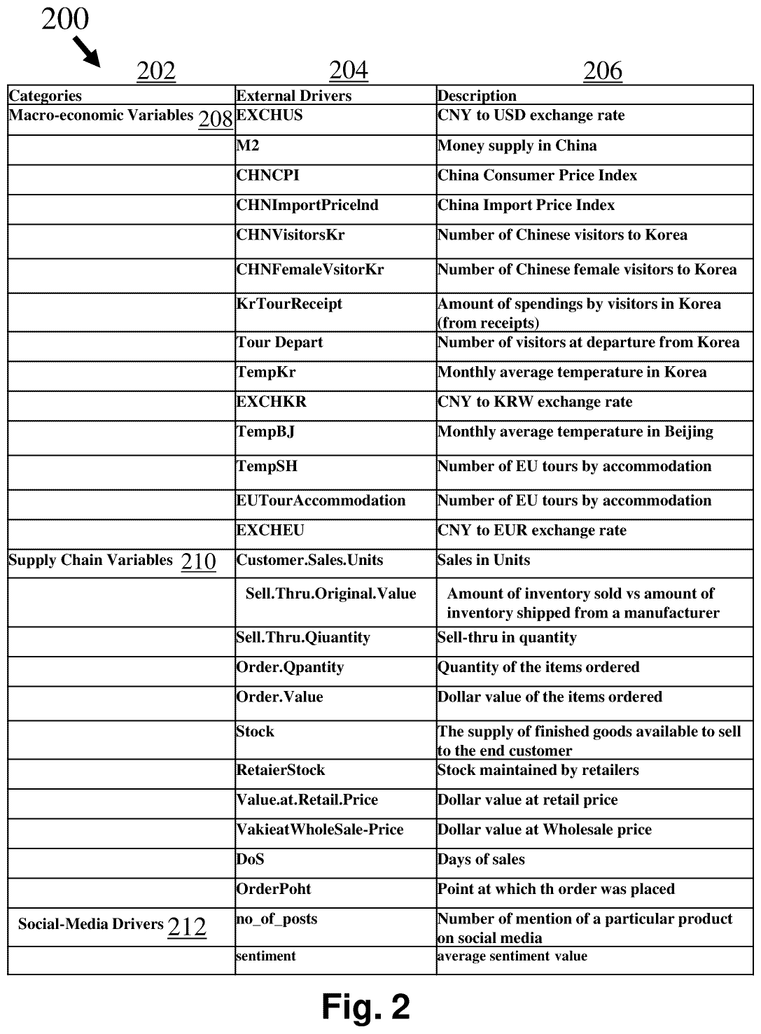

Referring to FIG. 2, a table 200 including three different types of factors influencing sales or demand for identification in the phase I 102 of a forecasting process is shown, according to various embodiments of the present disclosure.

In one embodiment, the phase I 102 in the forecasting process includes data identification. The data identification in the phase I 102 may identify all factors that may influence sales or demand, and then take action. Metadata that the forecasting process identifies includes three different categories of factors. A first category is macro-economic 208. A second category is supply chain 210. A third category is social media 212. Features may be indicated by, but not limited to, external drivers 204 in FIG. 2.

In FIG. 2, in the first category of factors of macro-economics 208, the features represented by the external drivers 204 are EXCHUS, M2, CHNCPI, CHNImportPriceInd, CHNVisitorsKr, CHNFemaleVisitorKr, KrTourReceipt, TourDepart, TempKr, EXCHKR, TempBJ, TempSH, EUTourAccomodation, and EXCHEU. Each external driver has description 206 for its function. For example, a description 206 for the external driver M2 in the first category of factors of macro-economics 208 is “money supply in China.” In a second example, the description 206 for the external driver CHNVisitorsKr is “number of Chinese visitors to Korea.”. In a third example, the description 206 for the external driver TempBJ is “monthly average temperature in Beijing.”.

In FIG. 2, in the second category of factors of the supply chain 210, the features represented by the external drivers 204 are “Customer.Sale.Unit”, “Sell.Thru.Original.Value”, “Sell.Thru.Quantity”, “Order.Quantity”, “Order.Value”, Stock, RetailerStock, “Value.at.Retail.Price”, “Value.at.Wholesale.Price”, “DoS”, and “OrderPoint”. As discussed above, each external driver 204 has description 206 for its function. For example, the description for the external driver “Order.Quantity” in the second category of factors of the supply chain 210 is quantity of the items ordered.

In FIG. 2, in the third category of factors of the social media 212, the features represented by the external drivers 204 are “no_of_posts” and sentiment. Each external driver 204 for social media 212 also has its own description 206. For example, the description for the external driver “no_of_posts” is number of mentions of a particular product on social media. In a second example, the description for external driver “sentiment” is average sentiment value, which means that the external driver “sentiment” represents information about a customer or a user's perception of a product, service, or a brand on the social media platform.

In one embodiment, in reference to FIG. 2, based on a target market of case study, features such as, but not limited to, order amounts or retailer's stock are factors in the category of supply chain 210 which may be provided by clients or users. Data related to macro-economics 208 and social media 212 may be leveraged from internal resources such as data storage centers for storing macro-economics 208 related data and data storage centers for the social media platforms. In one example, macro-economic data may be procured from various licensed websites. For example, data related to the number of Chinese visitors to Korea may be collected from websites of local airports in Korea. Data related to the weather in Korea may be collected from weather forecasting websites in Korea. In some examples, one or more web-scraping libraries may be customized to extract macro-economic data across multiple licensed websites and transform the macro-economic data into desired formats, such as a comma-separated values “csv” format or an Excel spreadsheet format “xlsx”.

In one embodiment, in order to collect social media data, application programming interface (APIs) or web scrapers may be used to extract data from one or more social media websites. Nowadays, most social media websites have developer accounts which require authentication or access tokens to establish a secure connection with the APIs to pull out the social media data. Data may be fetched for specific locations, which is known as spatial data. In some examples, a data corpus may be created with all the posts for a specific product on specific dates or months throughout a historical period in the social media websites.

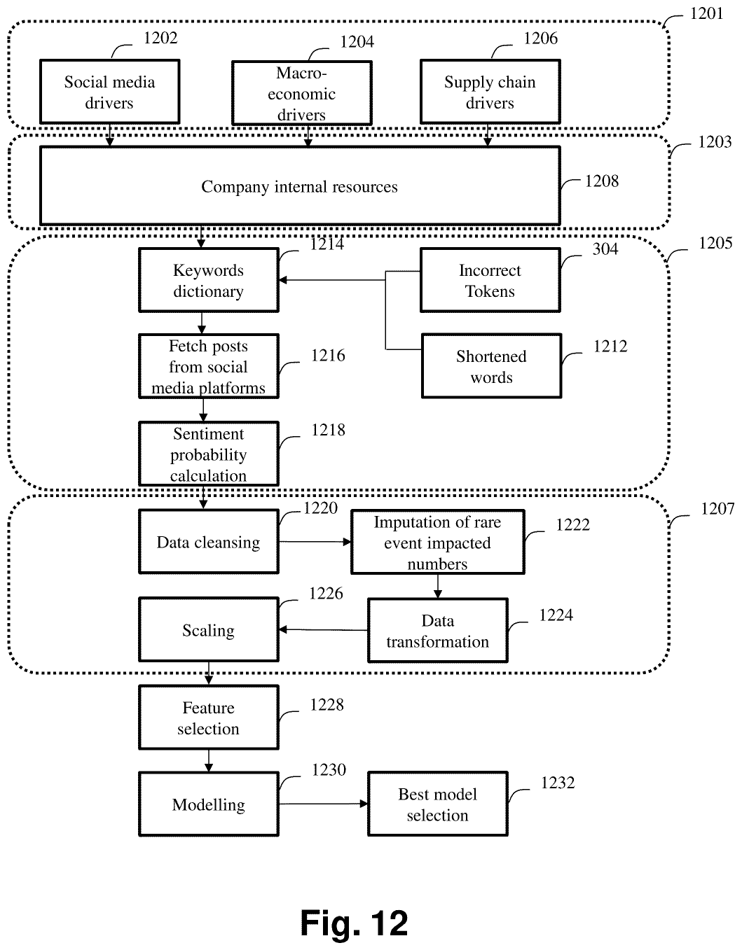

In one embodiment, the case study as shown in FIG. 2 is specific to the Asia Pacific region (e.g., China, Korea, etc.) since the majority of product sales is driven by Asia Pacific region with significant volatility in the data. For example, the study in the present disclosure includes 100 products and searching by keywords provides all the posts for a given product throughout history. In some examples, a short form may be used instead of a product name to avoid misspelling, e.g., shortened words 1212 in FIG. 12. For example, if the keyword is “Vaseline,” the short forms may be, but not limited to, vsln, vasln, or vaseln.

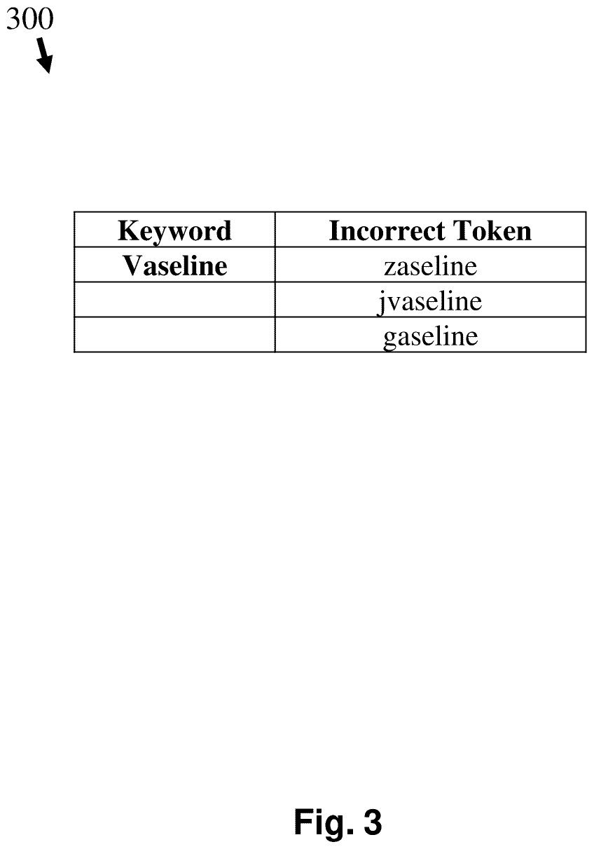

Referring to FIG. 3, a table 300 including an exemplary possible incorrect tokens for a keyword during data identification in a forecasting process is shown, according to various embodiments of the present disclosure.

In one embodiment, an algorithm such as a spell checker algorithm may be used in the present techniques to identify misspelled tokens. The spell checker algorithm may return a set of strings which differs from the keyword by k Levenshtein distance. The Levenshtein distance may be a string metric for measuring the difference between two sequences. For example, the Levenshtein distance between two words may be a minimum number of single character edits such as insertions, deletions, or substitutions, required to change one word into the other word.

Returning to FIG. 3, an exemplary table 300 shows one or more incorrect tokens for a keyword search for “Vaseline” when the Levenshtein distance is 1 (e.g., k=1) by the data identification in phase I of the forecasting process. The incorrect tokens include zaseline, jvaseline, and gaseline. These incorrect tokens have one or more similarities between each other and the keyword regarding their string metrics.

In one embodiment, fuzzy logic may be used in phase I of the forecasting process for the data identification. The fuzzy logic may be used on the posts from social media platforms to get similar keywords or misspelled keywords. The fuzzy logic is an approach which includes many-valued logic in which the truth value of variables may be any real number between 0 and 1. In some embodiments, the fuzzy logic represents partial truth, where the truth value may range between completely true or completely false. The fuzzy logic in the present disclosure may be used to enhance a dictionary even further. The fuzzy logic may be used to incorporate the words which may be misspelled but sound the same where a library in a phonetic algorithm may use.

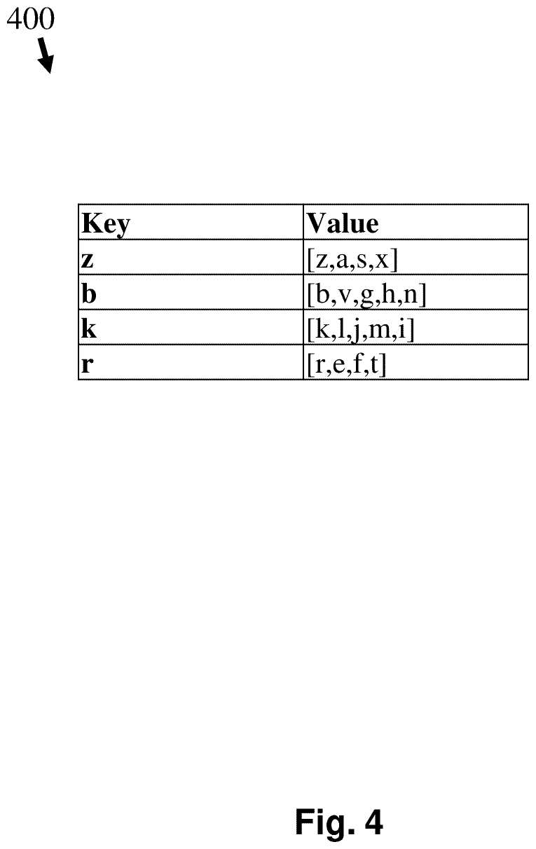

Referring to FIG. 4, a table 400 including an exemplary list of possible English alphabets for a key during data identification in a forecasting process is shown, according to various embodiments of the present disclosure.

In one embodiment, a filtering process may be used in phase I of the forecasting process for the data identification. The filtering process may be essential because the number of incorrect tokens may be high. First, all of the tokens with special characters may be removed. As shown in the table 400, a dictionary of a list of letters in the English alphabet is generated based on the key. In table 400, the key may be a letter, and values may be the letter and its adjacent letters on a keyboard (e.g., QWERTY keyboard layout for Latin-script alphabets). For example, as shown in the table 400, the values for the key “z” may be “z, a, s, and x” since these letters are adjacent to the letter “z” on the keyboard, which means that users of the keyboard are highly likely to click these buttons for these letters on the keyboard. In another example, as shown in the table 400, the values for the key “r” may be “r, e, f, and t” since these letters are adjacent to the letter “r” on the keyboard.

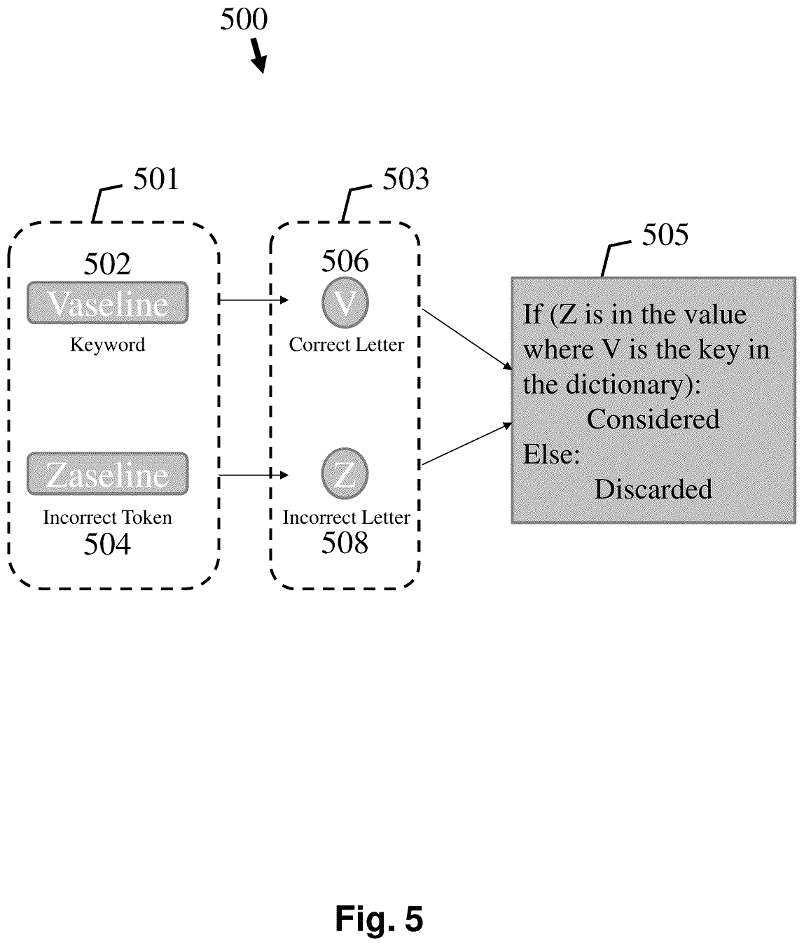

Referring to FIG. 5, a flow diagram 500 of filtering misspelled tokens by an algorithm is shown, according to various embodiments of the present disclosure.

In one embodiment, in blocks 502 and 504 in step 501, only tokens with a same length as the keyword are examined. For example, “Zaseline” in the block 504 has a same length as the keyword “Vaseline” in the block 502, and then the “Zaseline” and “Vaseline” may be compared in step 503. In the step 503, an algorithm to examine whether the tokens may be considered or discarded may be used. For example, the algorithm may compare each value in the tokens in blocks 502 and 504. The first value in the token “Zaseline” is “Z” which is different than the first value in the token “Vaseline,” and then the token “Zaseline” may be determined to be an incorrect token and may be discarded as shown in step 505.

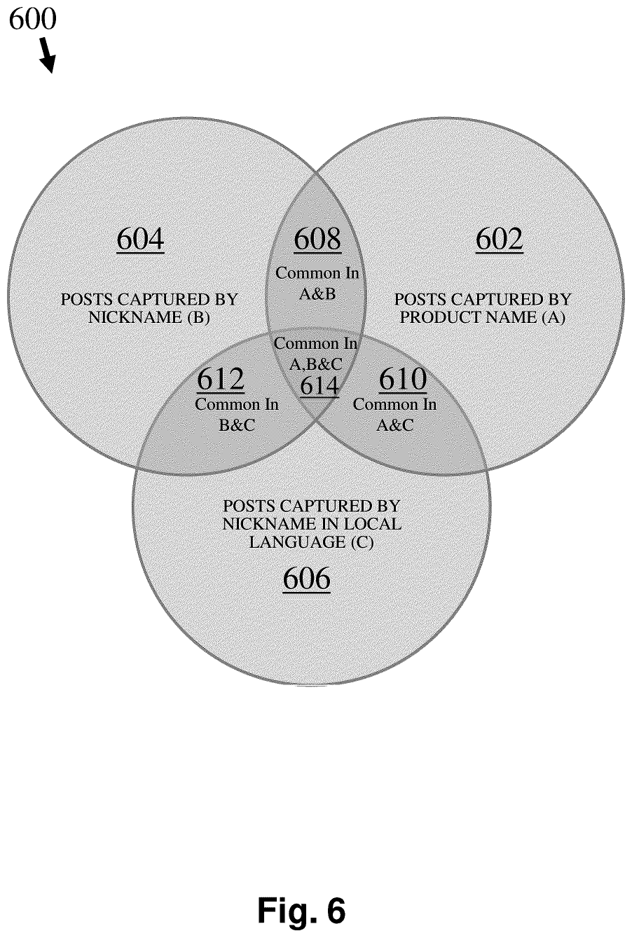

Referring to FIG. 6, posts fetched using different keywords is shown, according to various embodiments of the present disclosure.

In one embodiment, posts with short forms may be generated to be passed as a token to extract data from a social media platform. To generate a list of short forms for the keyword, all vowels may be removed from the keyword and then each vowel may be added one at a time to create various combinations. For example, if the keyword is Vaseline, the abbreviated forms may be, but not limited to, vsln, vasln, vseln, vaseln, etc. This list of short forms are apart from a domain dictionary which is created with universal short forms and domain specific short forms.

In one embodiment, a dictionary may be created with all possible tokens for each product in posts. All nicknames that people may use in social media platforms for a particular product may be collected. The nicknames may also be used as tokens. For example, referring back to FIG. 6, all posts from the social media platforms are collected by nicknames, nicknames in a local language, and a name of the particular product with short forms and misspelled tokens from social media platforms such as WeChat and SeinaWeibo since these social media platforms dominate China and Korea social media markets. To get final posts, a total number of posts n(AUBUC) may be calculated which is received from different keywords as below in Equation 1.

n(A∪B∪C)=n(A)+n(B)+b(C)−n(A∩B)−n(A∩C)−n(B∩C)+n(A∩B∩C) (Equation 1)

In Equation 1, n(A) 602 represents a number of posts by product name along with misspelled and short forms. n(B) 604 represents a number of posts by nickname. n(C) 606 represents a number of posts by nickname in local language. n(A∩B) 608 represents a number of posts by product name along with misspelled and short forms and by nickname. n(A∩C) 610 represents a number of posts by nickname and nickname in the local language. n(A∩C) 612 represents a number of posts by product name along with misspelled and short forms and by nickname. n(A∩B∩C) 614 represents a number of posts by product name along with misspelled and short forms, by nickname, and by nickname in the local language.

In one embodiment, after getting the number of posts from every social media platform by month and by product, an impact from social media platform may be determined. The number of posts with respect to demand and sales may be scaled and a function of the impact from each social media platform may be created. The function may be, but not limited to, a linear function. For example, as shown in Equation 2 below, a number of posts from two social media platforms is collected.

Y1=α(posts from WeChat)+(1−α)(posts from SeinaWeibo) (Equation 2)

In Equation 2, Y1 represents an impact of the post from two social media platforms. The first social media platform is WeChat and the second social media platform is SeinaWeibo. a represents a weightage of the posts from WeChat. A weightage of the posts from SeinaWeibo is represented by (1−α) since only posts from two social media platforms are considered in this example. In some embodiments, if there are more than two social media platforms, more weightages may be used to calculate Y1.

In one embodiment, after getting all posts for a particular product for a specific month, one or more sentiment probabilities is calculated, e.g., block 1218 in FIG. 12. For example, 7 different sentiment analyzers may be used. The sentiment analyzers may be from local servers in a local data center. In some embodiments, the sentiment analyzers may be from a third party company, a remote server, a cloud service, or a remote data center. Sentiment probabilities are specific for each product. The impact Y2 for all posts for the product for the month based on one or more sentiment probabilities is calculated as shown in Equation 3. The equation may be, but not limited to, a linear function.

Y2=α₁(sentiment probability 1)+α₂(sentiment probability 2)+ . . . +αₙ(sentiment probability n) (Equation 3)

In Equation 3, Y2 represents an impact of all post from social media platforms for the month based on one or more sentiment probabilities. α₁, α₂, . . . , αₙ are weights that may be equal or different based on user inputs. It is noted that the Equation 3 is not limited to posts from the social media platforms.

In one embodiment, referring back to Equation 3, two variables are used in Equation 3. First variables α₁, α₂, . . . , αₙ are numbers of posts based on weightage from respective social media platforms. Second variables are sentiment probabilities of the posts by month. Lag features of these two variables may be used to capture correlation. Lag features may be target values from previous periods for these two variables. For example, if a lag value of 1 is applied to the forecasting model, the posts in the social media platforms in the previous month for these two variables may be collected and used for the forecasting modelling. If a lag value of 12 is applied to the forecasting model, the posts in the social media platforms from the last year for these two variables may be collected and used for the forecasting modelling. A correlation may then be determined depending on which lags work best and which lag value may be selected.

Social media influencers may reach millions of people. If the influencers post something good or bad regarding a product, the demand for the particular product may be affected, but the effect may only be seen a particular period of time after the posts are made (e.g. after a month). Therefore, in some embodiments, one or more lags affecting the social media drivers are considered. In one embodiment, three lags are used.

In one embodiment, customer demographics, macroeconomic conditions, and business processes contribute to volatility in the retail market. Thus, the forecasting model may include the macro-economic factors that are considered to forecast the sales fetched from various websites. For example, the macroeconomic conditions include, but are not limited to, money supply in China, China consumer price index, China to Korea exchange rate, China to USD exchange rate, etc. As discussed above, at least three lags of drivers are considered. In some embodiments, sales from manufacturers to distributors is also forecasted, therefore, supply chain drivers such as, but not limited to, sell-thru quantity, order quantity, retailer stock, etc. and multiple lags of these drivers may be used.

### Phase II Data Pre-Processing

In one embodiment, Phase II 104 includes, but is not limited to, pre-processing data, data treatment, creation of additional drivers, altering data from weekly to monthly or any level based on the use case, and generating additional features along with handling data impacted by the rare events. In Phase II 104, one or more drivers may be calculated based on the supply chain data from the supply chain drivers provided, which is discussed above with respect to FIG. 2. For example, the supply chain drivers may include, but are not limited to, “DoS” or “order point”. In addition, one or more indicators may be used on the supply chain drivers such as “stock” out or “retailer stock” out.

In one embodiment, a time stamp for the one or more drivers may be daily, weekly, monthly, or yearly in a time series. In one example described herein, the analysis of using a model incorporating the social media data and macro-economic characteristics may be performed at the monthly level along with the supply chain drivers being at the weekly level, and data for macro-economic characteristics from one or more databases, suggested by clients, customers, businesses, or domains, is at the monthly level.

In one embodiment, in Phase II 104, a first stage in preparing data for predictive forecasting modelling or analysis is data cleansing, also known as data cleaning, e.g., block 1220 in FIG. 12. Data cleansing is crucial because the data cleansing enhances the quality of the data and boosts overall productivity. If there is a rare event impacted number in historical data that is in the forecasting process, the number may come back to normal based on the historical pattern. The rare event impacted number may interfere with the forecasting model and the forecasts from the forecasting process may not be accurate.

In one embodiment, in Phase II 104, four techniques are proposed herein to impute the rare event impacted numbers in order to get accurate forecasts. A first technique is replacing the rare event affected values in the forecasting data with historical data, and increasing the historical data by the percentage for year-on-year increase. The first technique may capture the year-on-year trend in the forecasting data.

In one embodiment, in Phase II 104, a second technique is that the rare event affected data may be replaced with the original forecasts for the time period. In some embodiments, substantial changes over time due to a variety of complicated characteristics that are not shown if the forecasting data is replaced with historical data. The second technique may need a high level of confidence that previous forecasts properly represent what may happen in the forecasting data if the rare event had not occurred. In some embodiments, in order to have an accurate forecast for a time period, the prediction may account for seasonality and trends.

In one embodiment, in Phase II 104, a third technique is looking at the last two years (or other prior time period) of data and replacing the rare event impacted data with geometric mean of the percentage increase or decrease of a month from its previous month for the last two years (or other prior time period). The third technique may help get month-on-month numbers and may also take care of trends.

In one embodiment, in Phase II 104, a fourth technique is using the forecasted value intended for the time period which uses past data and ensembles the past data with the actual values of the rare events using a different technique. The fourth technique also captures historical patterns along with the impact of the rare events by rare event numbers. These four techniques may be used across industries to update or correct the rare event impacted numbers to get an accurate analysis. It is noted that a combination of these four techniques may be used to replace a single rare event. In some embodiments, each technique may be weighted, or there may be a complex equation to combine outputs of the four techniques.

In one embodiment, all the data herein is compiled and concatenated by product and month. The number of lags may be selected for the data. If more lags are needed, less data is available. In some embodiments, for month to month data, the data is separated by month. However, the data may be separated by nK (e.g., a multiple of days). In an example, after getting a final dataset lags until three, some data are taken for all the features and some data are transformed using differencing. The formula for the number of lags (k) is shown as in Equation 4. It is noted that the observation is a time series, which is a set of data points indexed in time order or a sequence taken at successive equally spaced points in time.

Observation(t)=Observation(t−k) (Equation 4)

Differencing is shown in Equation 5. Differencing is performed by subtracting a previous observation from a current observation. In an example, the differencing calculates the time series between the current month (t) and the previous month (t−1). In some embodiments, the differencing may be calculated between a time series between, but not limited to, a current week and previous week, or today and yesterday.

Difference(t)=Observation(t)−Observation(t−1) (Equation 5)

### Phase III Feature Selection and Modelling

In one embodiment, the forecasting data may be split into training and testing once all of the features have been converted and lags have been formed. The training herein may be training for demand by month. The external drivers discussed above may be the features. All of the external drivers with the lags may be trained on. In an example, in the training data, three years of monthly level data may be evaluated. Testing is done on a year's worth of data. Training data may be further analyzed and testing data may be utilized to determine an optimal forecasting model.

In one embodiment, feature selection in the forecasting process may be used to reduce the number of input variables. The reduction of the number of input variables may decrease an overall computational cost of forecasting modelling. In some examples, the reduction of the number of input variables may also increase the forecasting model's performance. In order to determine right features to be selected, a correlation test may be done between all features with the sales in the training dataset.

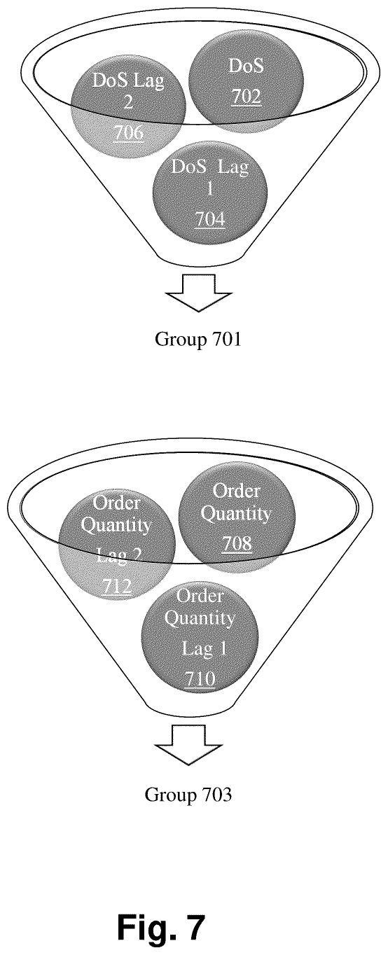

Referring to FIG. 7, feature selection in a forecasting process is shown, according to various embodiments of the present disclosure. The feature selection is also shown in block 1228 in FIG. 12.

In an embodiment, different groups of features are created and transformed, and lagged variables of the features are grouped together which is shown in FIG. 7. The training of the forecasting model for demand is by month. In FIG. 7, external drivers discussed above are the features. All of the external drivers with the lags are trained on and then put into groups, e.g., groups 701 and 703 in FIG. 7. The forecasting model is trained on each group, and then the group having the least error is determined. It is noted that only one feature and its lags are in a group, and the forecasting model determines which lag correlates best with demand changes.

In FIG. 7, only the most correlated feature is utilized for predictions from each group, and then all of the groups' most correlated features are combined into a single bucket. The forecasting model is then fitted and error metric value checked by taking only one variable from the bucket at a time. The error metric value may be mean absolute percentage error (MAPE) or weighted average percentage error (WAPE). The checking of the error metric value may have two steps. A first step is getting best models by checking the least error metric value among the combinations of exogeneous variables and algorithms. For example, this step may be performed for one variable, two variables, or three variables at a time to choose three best models for each of the combinations of the variables. A second step is selecting a best model based on a least error metric value out of the three best models obtained earlier in the first step. Therefore, combinations of exogeneous variables and different forecasting algorithms are made, and the combination of exogeneous variables with the least error metric value is considered to be the best fitted model. In an example, using three exogenous variables may be restricted to avoid overfitting. In the present disclosure, the goal of feature selection in the forecasting process is to see how well independent factors, such as social media factors, may create accurate forecasts.

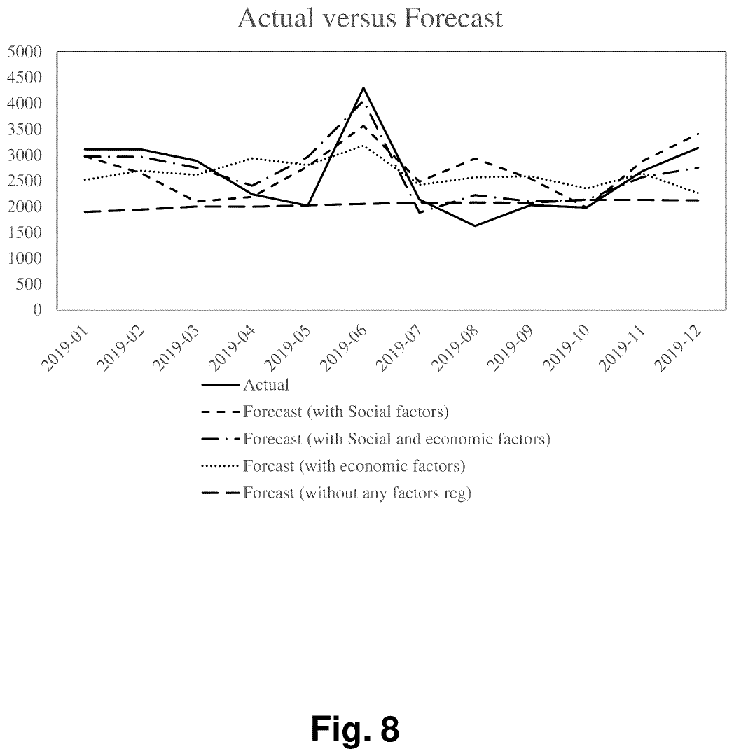

Referring to FIG. 8, a comparison of actual value and forecasted values generated from four forecasting models is shown, according to various embodiments of the present disclosure.

In FIG. 8, the comparisons of actual values of sell-in quantity and forecasted values of sell-in quantity from four forecasting models may be shown. The four forecasting models include a forecasting model with social factors, a forecasting model without any factors (e.g., social media factors or macro-economic factors) as regressors, a forecasting model with social and economic factors, and a forecasting model with economic factors. The comparison in FIG. 8 may be, but are not limited to, line diagrams. The horizontal axis of the comparison may be month and the vertical axis of the comparison may be sales quantity. The forecasting model may use a univariate time series forecast as a benchmark (e.g., the forecasting model without any factors in FIG. 8). Statistical models along with various machine learning techniques with independent variables may be tested to capture linear trends and to check for cointegration. For example, as shown in FIG. 8, the forecasting model with just historical data (e.g., the forecasting model without any factors in FIG. 8) may not be able to capture peaks in the forecasting data. The models get improved further when economic factors are passed to the models, and show the patterns in the forecasting data. As shown in FIG. 8, the forecasting model with variance of social and economic factors may be closer to the actual values of sell-in quantity. The forecasting model with variance of both social and economic factors may provide better results by capturing trends and seasonality.

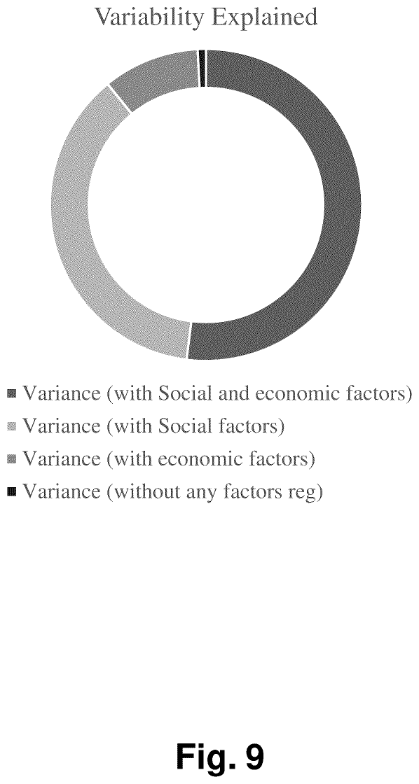

Referring to FIG. 9, variability in actual data explained by different forecasting models is shown, according to various embodiments of the present disclosure.

In one embodiment, as shown in FIG. 9, the total variability in the actual data is divided by four sections. Each section represents an amount of variability out of the total variability in the actual data that may be explained by each forecasting models. The forecasting models include the forecasting model with social factors, the forecasting model without any factors (e.g., social media factors or macro-economic factors) as regressors, the forecasting model with social and economic factors, and the forecasting model with economic factors, which are discussed above. In FIG. 9, if the section is larger, then the amount of variability explained by the corresponding forecasting model may also be larger. For example, since the section explained by the forecasting model with the social and economic factors is larger, the forecasting model with the social and economic factors captures more variabilities present in the actual data. In addition, the forecasting model with the social and economic factors provides more effective forecasts. In contrast, the section explained by the forecasting model without any factors is much smaller than the sections explained by other forecasting models, which means that the forecasting model without any factors provides much less effective forecasts than other forecasting models. It is noted that data elements that improve forecast accuracy may be from social media drivers, which appear more frequently in the forecasting model that generates the best accuracy relative to other data elements.

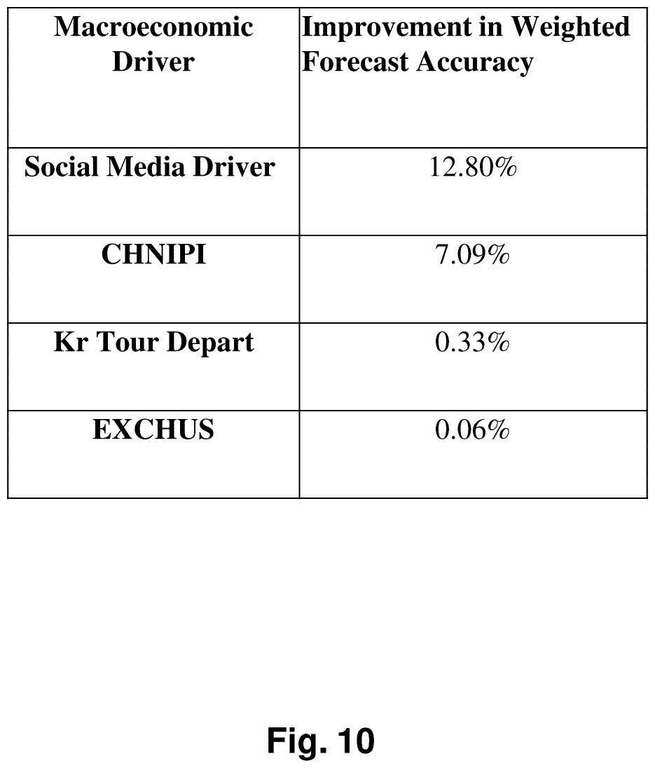

Referring to FIG. 10, an overview of improvement on forecast accuracy by including different macroeconomic drivers in a forecasting model is shown, according to various embodiments of the present disclosure.

In one embodiment, as shown in FIG. 10, each macroeconomic driver has an impact on the weighted forecast accuracy. For example, the social media driver increases the weighted forecast accuracy by 12.8%. As discussed above, compared with other macroeconomic drivers, the social media driver increases the forecast accuracy more than other macroeconomic drivers.

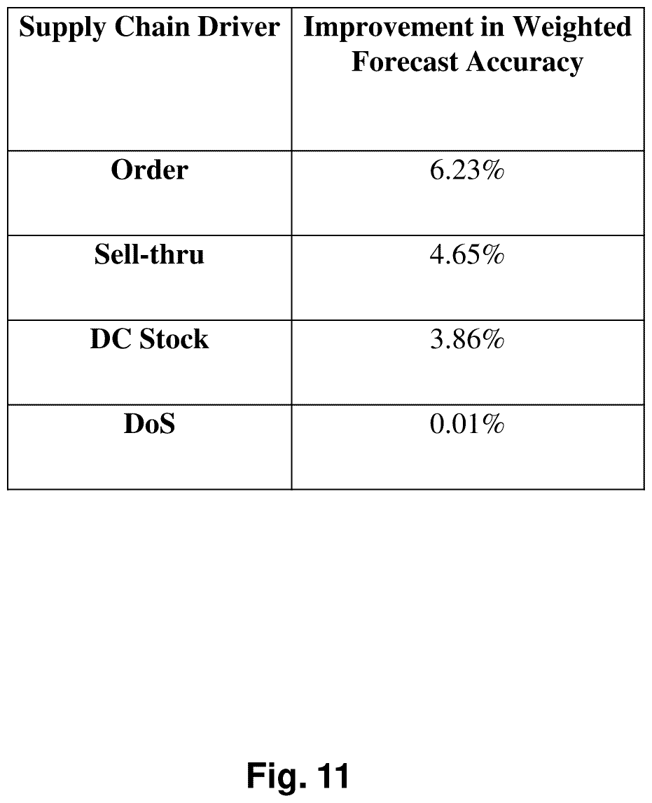

Referring to FIG. 11, an overview of improvement on forecast accuracy by including different supply chain drivers in a forecasting model is shown, according to various embodiments of the present disclosure.

In one embodiment, as shown in FIG. 11, each supply chain driver has an impact on in weighted forecast accuracy. For example, the “order” driver increases the weighted forecast accuracy by 6.23%, which is higher than other supply chain drivers such as “sell through” driver, “DC stock” driver, and “DoS” driver.

Referring to FIG. 12, a flow diagram of a forecasting modelling process is shown, according to various embodiments of the present disclosure.

In block 1201, a feature identification process is presented. The feature identification process includes identifying features from social media drivers 1202, macro-economical drivers 1204, and supply chain drivers 1206. After identifying the features, data relevant to the features can be retrieved from various sources, such as company internal resources as shown in block 1208, which is part of a data extraction process 1203.

In block 1214, receiving forecasting data from the company internal resources and receiving incorrect tokens 504 and shortened words 1212 to create a keywords dictionary. In block 1216, posts are fetched from social media platforms as shown in Equation 2 above. In block 1218, sentiment probability for the posts are calculated as shown in Equation 3 above. It is noted that the blocks 304, 1212, 1214, 1216, and 1218 are part of a data acquisition process 1205.

Next, forecasting data from the sentiment probability calculation 1218 is sent to block 1220 for data cleansing. After data cleansing, imputation of rare event impacted numbers is applied to the forecasting data in block 1222. The forecasting data is then transformed in block 1224. After transformation, the forecasting data is scaled in block 1226. It is noted that the blocks 1220, 1222, 1224, and 1226 are part of data pre-processing process 1207.

In block 1228, a feature selection is performed for the forecasting data received from the data pre-processing process 1207. The forecasting data is then sent for modelling in block 1230. After that, a best model is being selected to be used (block 1232) based on the comparison of the modelling results in the block 1230.

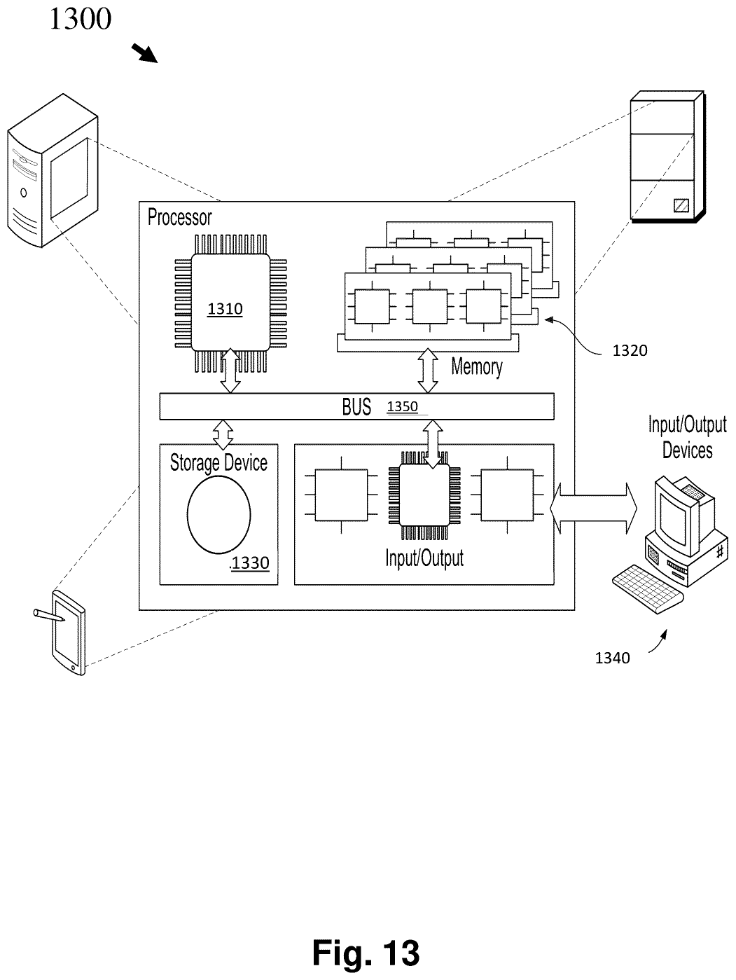

An example of a type of user's computer is shown in FIG. 13, which shows a schematic diagram of a generic computer system 1300. User of the system described above may have user interface (UI) to be implemented as a software application and the software application may be used in the user's computer. The user's computer may be a desktop computer or a laptop.

The system 1300 may be used for the operations described in association with any of the method, according to one implementation. The functions and the algorithms described above may be performed in the software application in the user's computer. For example, a user of the UI may use the system 1300 to access the user interface. The system 1300 includes a processor 1310, a memory 1320, a storage device 1330, and an input/output device 1340. Each of the components 1310, 1320, 1330, and 1340 is interconnected using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330 to display graphical information, e.g., the user interface on the input/output device 1340.

As discussed earlier, the processor 1310 may be used to calculate a total number of posts in Equation 1 and a number of posts from two social media platforms in Equation 2. The processor 1310 may be used to create a model, e.g., the forecasting model, as discussed earlier. The processor 1310 may execute the processes, formula, and algorithm in the present disclosure.

The memory 1320 stores information within the system 1300. In one implementation, the memory 1320 is a computer-readable medium. In one implementation, the memory 1320 is a volatile memory unit. In another implementation, the memory 1320 is a non-volatile memory unit.

The storage device 1330 is capable of providing mass storage for the system 1300. In one implementation, the storage device 1330 is a computer-readable medium. In various different implementations, the storage device 1330 may be a floppy disk device, a hard disk device, an optical disk device, or a tape device. The storage device 1330 may store data such as input data or training data, as discussed earlier.

The input/output device 1340 provides input/output operations for the system 1300. In one implementation, the input/output device 1340 includes a keyboard and/or pointing device. In another implementation, the input/output device 1340 includes a display unit for displaying graphical user interfaces.

While this specification contains many specific implementation details, these should not be construed as limitations on the scope of what may be claimed, but rather as descriptions of features that may be specific to particular embodiments.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

Obviously, numerous modifications and variations are possible in light of the above teachings. It is therefore to be understood that within the scope of the appended claims, embodiments of the present disclosure may be practiced otherwise than as specifically described herein.

What is claimed is:

1. A method for creating an improved forecasting model, the method comprising:
identifying a plurality of drivers affecting actual sales or demand of a product or service;
receiving a respective data set for each of the drivers;
generating one or more lagged data sets for each driver by applying one or more lags to the data set associated with the driver;
for each driver:
forming a group of data sets by grouping the data set associated with the driver with the one or more lagged data sets for the driver; and
selecting a data set in the group of data sets that best correlates with sales or demand changes of the product or service;
determining which one or more of the selected data sets for the drivers increases forecasting accuracy for sales or demand of the product or service; and
training a forecasting model using the one or more selected data sets.

2. The method of claim 1, further comprising modifying the data set associated with at least one of the drivers to compensate for one or more rare events.

3. The method of claim 1, wherein the plurality of drivers comprises one or more social media drivers and one or more non-social media drivers.

4. The method of claim 1, further comprising calculating error metric values for the forecasting model.

5. The method of claim 4, wherein the error metric values include mean absolute percentage error and weighted average percentage error.

6. The method of claim 1, further comprising identifying the respective data set for each of the drivers based on a keywords dictionary before applying one or more lags to the data set, the keywords dictionary including misspelled words and shortened words for each of the drivers.

7. The method of claim 1, wherein the forecasting model is used to predict demand based on new input data.

8. The method of claim 1, further comprising cleansing the respective data set for each of the drivers before applying one or more lags to the data set.

9. A system for creating an improved forecasting model, the system comprising:
a memory; and
one or more processors coupled with the memory, wherein the one or more processors, when executed, perform operations comprising:
identifying a plurality of drivers affecting actual sales or demand of a product or service;
receiving a respective data set for each of the drivers;
generating one or more lagged data sets for each driver by applying one or more lags to the data set associated with the driver;
for each driver:
forming a group of data sets by grouping the data set associated with the driver with the one or more lagged data sets for the driver; and
selecting a data set in the group of data sets that best correlates with sales or demand changes of the product or service;
determining which one or more of the selected data sets for the drivers increases forecasting accuracy for sales or demand of the product or service; and
training a forecasting model using the one or more selected data sets.

10. The system of claim 9, wherein the operations further comprise modifying the data set associated with at least one of the drivers to compensate for one or more rare events.

11. The system of claim 9, wherein the plurality of drivers comprises one or more social media drivers and one or more non-social media drivers.

12. The system of claim 9, wherein the operations further comprise calculating error metric values for the forecasting model.

13. The system of claim 12, wherein the error metric values include mean absolute percentage error and weighted average percentage error.

14. The system of claim 9, wherein the operations further comprise identifying the respective data set for each of the drivers based on a keywords dictionary before applying one or more lags to the data set, the keywords dictionary including misspelled words and shortened words for each of the drivers.

15. The system of claim 9, wherein the forecasting model is used to predict demand based on new input data.

16. The system of claim 9, wherein the operations further comprise cleansing the respective data set for each of the drivers before applying one or more lags to the data set.

17. A non-transitory computer readable medium containing computer-readable instructions stored therein for causing a computer processor to perform operations comprising:
identifying a plurality of drivers affecting actual sales or demand of a product or service;
receiving a respective data set for each of the drivers;
generating one or more lagged data sets for each driver by applying one or more lags to the data set associated with the driver;
for each driver:
forming a group of data sets by grouping the data set associated with the driver with the one or more lagged data sets for the driver; and
selecting a data set in the group of data sets that best correlates with sales or demand changes of the product or service;
determining which one or more of the selected data sets for the drivers increases forecasting accuracy for sales or demand of the product or service; and
training a forecasting model using the one or more selected data sets.
